(19) United States
(12) Patent Application Publication
(10) Pub. No.: US 2018/0197192 A1
(43) Pub. Date: Jul. 12, 2018

(54) METHOD AND DEVICE FOR IDENTIFYING PREFERENTIAL REGION OF PRODUCT

(71) Applicant: Hefei University of Technology, Hefei (CN)

(72) Inventors: Qiang ZHANG, Hefei (CN); Shanlin YANG, Hefei (CN); Anning WANG, Hefei (CN); Zhanglin PENG, Hefei (CN); Xin Ni, Hefei (CN); Minglun REN, Hefei (CN); Xiaonong LU, Hefei (CN)

(21) Appl. No.: 15/866,439

(22) Filed: Jan. 9, 2018

(30) Foreign Application Priority Data
Jan. 12, 2017 (CN) 201710022878.9

(51) Int. Cl. G06Q 30/02

(52) U.S. Cl. CPC G06Q 30/0205; G06Q 30/0203; G06Q 30/0201

(57) ABSTRACT

The present invention relates to a method and an apparatus for identifying a preferential region for a product. The method includes: obtaining comment texts of users in different regions for a to-be-analyzed product, and extracting product features of the to-be-analyzed product from the obtained comment texts; determining sentiment polarities of the users for the product features in the comment texts; calculating associations between sentiment orientations of the product features and the regions; extracting product features with regional preferences from the product features; and determining, for each extracted product feature with a regional preference, a preferential region for the product feature in view of the sentiment polarities. For content of fragmental and random online comments on the product, the present invention can provide a preferential region, enable an enterprise to formulate a more specific marketing strategy, and drive the enterprise to implement the regional product marketing strategy.

### FIELD OF THE INVENTION

The present invention relates to the field of text mining technologies, and in particular, to a method and an apparatus for identifying a preferential region for a product.

### BACKGROUND OF THE INVENTION

With fast development of a Web2.0 technology, more users choose to publish their shopping experience by using online social media. Research shows that 77% of consumers browse online comments before buying. In comparison with individual recommendations, 75% of consumers prefer to believe online comments on products. A research result shows that online comments on products are playing an increasingly important role in a user's buying decision, and have become important information resources of an enterprise.

From a perspective of spatial distribution of users, users in different regions have different preferences for product features due to environmental, cultural, and economic differences in the regions. Identifying feature preferences in different regions can drive an enterprise to implement a regional product marketing strategy. However, because content of online comments on products is fragmental and random, there is high complexity in identifying preferential regions for product features from the online comments on products.

### SUMMARY OF THE INVENTION

In view of the foregoing disadvantage, the present invention provides a method and an apparatus for identifying a preferential region for a product. A preferential region can be provided to enable an enterprise to formulate a more specific marketing strategy, and drive the enterprise to implement the regional product marketing strategy.

According to a first aspect, the present invention provides a method for identifying a preferential region for a product, where the method includes:

obtaining comment texts of users in different regions for a to-be-analyzed product, and extracting product features of the to-be-analyzed product from the obtained comment texts, where the regions are tiers of cities to which the users belong or are regions to which the users belong;

determining, according to an opinion word about each product feature in each comment text, a sentiment polarity of a user for the product feature in the comment text;

calculating, according to the sentiment polarity of each product feature in each comment text including the product feature and a region to which the user of the comment text including the product feature belongs, an association between a sentiment orientation of the product feature and the region;

extracting product features with regional preferences from the product features according to associations between sentiment orientations of the product features and the regions; and

determining, for each extracted product feature with a regional preference according to a difference between a calculated value and an expected value of a quantity of comment texts including the product feature and with a same sentiment polarity for the product feature in each region, a preferential region for the product feature in view of the sentiment polarity.

Optionally, the step of extracting product features of the to-be-analyzed product from the obtained comment texts includes:

performing Chinese word segmentation on each comment text, and extracting nouns and noun phrases from a word segmentation result;

extracting a frequent item set from the extracted nouns and noun phrases by using an association rule; and

performing synonym aggregation on nouns and/or noun phrases in the frequent item set, and removing non product feature words from the frequent item set.

Optionally, the step of determining, according to an opinion word about each product feature in each comment text, a sentiment polarity of a user for the product feature in the comment text includes:

determining a type of a sentiment lexicon to which the opinion word belongs; and

determining, according to the type of the sentiment lexicon, the sentiment polarity of the user for the product feature in the comment text.

Optionally, the opinion word about each product feature in each comment text is an adjective in a preset quantity of characters near the product feature in the comment text.

Optionally, the association between the sentiment orientation of each product feature and the region is calculated by using the following formula:

$${χ}^{2} = \sum \frac{{( {n}_{kj} - {E}_{kj} )}^{2}}{{E}_{kj}}$$

where χ² is the association between the sentiment orientation of the product feature and the region, nₖⱼ is a calculated value of a quantity of comment texts including the product feature and with a sentiment polarity j for the product feature in a k^{th} region, and Eₖⱼ is an expected value of the quantity of comment texts including the product feature and with the sentiment polarity j for the product feature in the k^{th} region.

Optionally, the expected value Eₖⱼ is calculated by using the following formula:

$${E}_{kj} = \frac{{R}_{k} {C}_{j}}{n}$$

where n is a total quantity of the obtained comment texts, Cⱼ is a calculated value of a quantity of comment texts including the product feature and with the sentiment polarity j for the product feature, and Rₖ is a calculated value of a quantity of comment texts including the product feature in the k^{th} region to which the user belongs.

Optionally, the step of determining a preferential region for the product feature in view of the sentiment polarity includes:

calculating the difference between the calculated value and the expected value of the quantity of comment texts including the product feature with the sentiment polarity in each region; and

using a region with a greatest difference among the regions as the preferential region for the product feature in view of the sentiment polarity.

Optionally, the method further includes:

after extracting the product features of the to-be-analyzed product from the obtained comment texts, matching each product feature with a product attribute model in a configuration document of the to-be-analyzed product, and using the preferential region for the product feature as a preferential region for the product attribute model.

Optionally, the method further includes:

separately identifying preferential regions for a plurality of products that are in a same category as the to-be-analyzed product; and forming preferential regions for products in the category according to the preferential regions for the plurality of different products in the same category.

According to a second aspect, the present invention provides an apparatus for identifying a preferential region for a product, where the apparatus includes:

a first feature extraction module, configured to obtain comment texts of users in different regions for a to-be-analyzed product, and extract product features of the to-be-analyzed product from the obtained comment texts, where the regions are tiers of cities to which the users belong or are regions to which the users belong;

a sentiment polarity determining module, configured to determine, according to an opinion word about each product feature in each comment text, a sentiment polarity of a user for the product feature in the comment text;

an association calculation module, configured to calculate, according to the sentiment polarity of each product feature in each comment text including the product feature and a region to which the user of the comment text including the product feature belongs, an association between a sentiment orientation of the product feature and the region;

a second feature extraction module, configured to extract product features with regional preferences from the product features according to associations between sentiment orientations of the product features and the regions; and

a preferential region calculation module, configured to determine, for each extracted product feature with a regional preference according to a difference between a calculated value and an expected value of a quantity of comment texts including the product feature and with a same sentiment polarity for the product feature in each region, a preferential region for the product feature in view of the sentiment polarity.

In the method and apparatus for identifying a preferential region for a product according to the present invention, first, product features of a to-be-analyzed product are extracted from comment texts; then based on sentiment polarities of the product features and regions to which comment users belong, product features with regional preferences are extracted; and finally, for the product features with regional preferences, based on a calculated value and an expected value of a quantity of comment texts including a product feature with a sentiment polarity, a preferential region for the product feature is determined in view of the sentiment polarity. Up to now, a preferential region for each product feature with a regional preference is obtained in view of different sentiment polarities. It can be seen that, for content of fragmental and random online comments on the product, the method for identifying a preferential region according to the present invention can provide a preferential region, enable an enterprise to formulate a more specific marketing strategy, and drive the enterprise to implement the regional product marketing strategy.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 shows a schematic flowchart a method for identifying a preferential region for a product.

### DETAILED DESCRIPTION OF THE INVENTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments that persons of ordinary skill in the art obtain without creative efforts based on the embodiments of the present invention shall fall within the protection scope of the present invention.

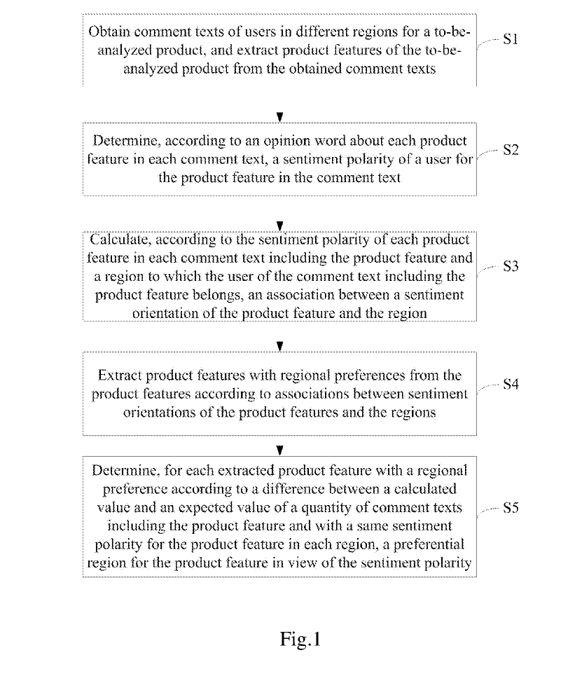

According to a first aspect, the present invention provides a method for identifying a preferential region for a product. As shown in FIG. 1, the method specifically includes the following steps:

S1. Obtain comment texts of users in different regions for a to-be-analyzed product, and extract product features of the to-be-analyzed product from the obtained comment texts, where the regions are tiers of cities to which the users belong or are regions to which the users belong.

It may be understood that, the tiers of the cities to which the users belong may be as follows: For example, as known according to the China City Tier Classification Standard in 2016, cities include tier-1 cities, tier-2 cities, tier-3 cities, and cities at lower tiers, that is, the tiers of the cities include tier 1, tier 2, tier 3, and lower tiers. The tiers of the cities reflect regional economy. With respect to the regions, for example, cities or towns may be classified into seven regions according to natural and geographical features in China, for example, East China, South China, North China, Central China, North East, North West, and South West. The regions reflect regional humanities and environments. It can be seen that, the regions in the present invention may be the tiers of the cities in which the comment users are located, or may be the regions to which the comment users belong.

It may be understood that, the product features are parameters that can reflect some features of the product. For example, for a vehicle, product features include exterior, space, fuel consumption, interior, and power.

S2. Determine, according to an opinion word about each product feature in each comment text, a sentiment polarity of a user for the product feature in the comment text.

It may be understood that, the opinion word can reflect a sentiment orientation of the user for the product feature of the to-be-analyzed product, for example, is “like”, “dislike”, “all right”, or “so-so”.

It may be understood that, the sentiment polarity is an extreme sentiment orientation. For example, opinion words may be classified into two extremes, where one is positive, “like”, and the other is negative, “dislike”.

S3. Calculate, according to the sentiment polarity of each product feature in each comment text including the product feature and a region to which the user of the comment text including the product feature belongs, an association between a sentiment orientation of the product feature and the region.

It may be understood that, if the sentiment orientation of the product feature is independent of the region, the association is weak. If the sentiment orientation of the product feature is not independent of the region, and the dependence is strong, it indicates that the association is strong.

S4. Extract product features with regional preferences from the product features according to associations between sentiment orientations of the product features and the regions.

It may be understood that, the regional preferences indicate that the sentiment orientations of the product features are not independent of the regions to which the comment users belong, and that the users in the different regions have different sentiment orientations.

S5. Determine, for each extracted product feature with a regional preference according to a difference between a calculated value and an expected value of a quantity of comment texts including the product feature and with a same sentiment polarity for the product feature in each region, a preferential region for the product feature in view of the sentiment polarity.

It may be understood that, if the sentiment polarity is positive, the preferential region is a region in which the user has an obvious liking; if the sentiment polarity is negative, the preferential region is a region in which the user has an obvious disliking.

In the method for identifying a preferential region for a product according to the present invention, first, product features of a to-be-analyzed product are extracted from comment texts; then based on sentiment polarities of the product features and regions to which comment users belong, product features with regional preferences are extracted; and finally, for the product features with regional preferences, based on a calculated value and an expected value of a quantity of comment texts including a product feature with a sentiment polarity, a preferential region for the product feature is determined in view of the sentiment polarity. Up to now, a preferential region for each product feature with a regional preference is obtained in view of different sentiment polarities. It can be seen that, for content of fragmental and random online comments on the product, the method for identifying a preferential region according to the present invention can provide a preferential region, enable an enterprise to formulate a more specific marketing strategy, and drive the enterprise to implement the regional product marketing strategy.

In specific implementation, S1 may be but is not limited to obtaining a large quantity of online comments on the product on social media by using a web crawler. The obtained comment text may be expressed in a form of a set: R={r₁,r₂, . . . , rₙ}. Each comment r₁ expresses opinions and attitudes of a user uₖ about several features of the product, and may be considered as a “user-feature-opinion” set, namely, {(uₖ,fⱼ,oⱼ)|fⱼεr₁}, where fⱼ is a product feature, and oⱼ is an opinion.

In specific implementation, the product features may be extracted from the comment texts in a plurality of manners in S1. An optional manner is:

S11. Perform Chinese word segmentation on each comment text, and extract nouns and noun phrases from a word segmentation result.

S12. Extract a frequent item set from the extracted nouns and noun phrases by using an association rule.

S13. Perform synonym aggregation on nouns and/or noun phrases in the frequent item set, and remove non product feature words from the frequent item set.

Herein, word segmentation is performed on the comment text first, and the nouns and noun phrases are extracted; the frequent item set is extracted, and then synonym aggregation is performed on the nouns and noun phrases in the frequent item set, and some non product feature words or the like are removed. In this way, the product features of the product are obtained.

In specific implementation, in S11, currently there are a plurality of word segmentation means. For example, word segmentation is performed by using Jieba Chinese word segmentation software, and then the nouns and noun phrases are extracted from the word segmentation result. The extraction of the nouns and noun phrases may be implemented in a part-of-speech tagging manner. In S12, the association rule, for example, an Apriori algorithm, is used to mine the nouns and noun phrases to form the frequent item set, for example, a first frequent item set or a second frequent item set. In S13, synonym aggregation is performed on the nouns and noun phrases in the frequent item set. For example, words such as “exterior”, “shape”, and “body” of a vehicle product all reflect overall conditions of the exterior of a vehicle. After aggregation is performed by using a synonym lexicon, “exterior” is used for expression. In S13, the non product feature words in the frequent item set are further removed, Mainly, single-word nouns are removed, and some nouns or noun phrases that are frequently used but are not product features, such as “question” and “family”, are filtered.

The following uses the vehicle as the to-be-analyzed product, and aggregates the extracted features by using the synonym lexicon. A specific aggregation table is shown in the following Table 1.

TABLE 1
Product feature aggregation table

| Product feature | Feature set |
|---|---|
| Exterior | Exterior, face score, tail, and headlight |
| Space | Space, rear seat, trunk, head space, internal space, and |
| | front seat |
| Interior | Interior, color, material, central control, display screen, |
| | particulars, and craftsmanship |
| Fuel | Fuel consumption, urban fuel consumption, high-speed |
| consumption | fuel consumption, and average fuel consumption |
| Power | Power, engine, start, speed, acceleration, and horsepower |
| Manipulation | Manipulation, steering wheel, rear mirror, brake, clutch, |
| | and accelerator |
| Comfortability | Comfortability, suspension, shock absorption, resonance, |
| | seat, and sound insulation |
| Price/ | Price/performance ratio, price, configuration, and |
| performance | performance |
| ratio | |

From the foregoing Table 1, it can be seen that, after various features are aggregated, eight product features are obtained, that is, exterior, space, interior, fuel consumption, power, manipulation, comfortability, and price/performance ratio.

In specific implementation, in S2, because an opinion word is generally near a feature word and is generally an adjective, for example, “The exterior looks gorgeous, and the head is quite plump”, an adjective near the product feature can be found as an opinion word. For example, the opinion word about the product feature in the comment text is an adjective in a preset quantity of characters near the product feature in the comment text.

In specific implementation, the sentiment polarity of the user for the product feature may be determined in a plurality of manners in S2. An optional manner is: determining a type of a sentiment lexicon to which the opinion word belongs; and determining, according to the type of the sentiment lexicon, the sentiment polarity of the user for the product feature in the comment text.

For example, the sentiment lexicon is of a positive type or a negative type. If the type of the sentiment lexicon is a positive lexicon, the sentiment polarity of the user for the product feature in the comment text is positive, for example, “like”. If the type of the sentiment lexicon is a negative lexicon, the sentiment polarity of the user for the product feature in the comment text is negative, for example, “dislike”. For example, using n comment texts as an example, sentiment polarities of the eight product features obtained through aggregation in the foregoing Table 1 and user satisfaction in each comment text are organized into structured data shown in the following Table 2.

TABLE 2
Structured data table of the sentiment polarities
of the eight product features and user satisfaction

| | | Product feature | | | | |
|---|---|---|---|---|---|---|
| | | | | | Price/perfor- | Satis- |
| Comment | Place | Exterior | Space | . . . | mance ratio | faction |
| k = 1 | Hefei | Positive | Negative | . . . | Positive | 0.875 |
| . . . | . . . | . . . | . . . | . . . | . . . | . . . |
| k = n | Wuhu | Negative | Negative | . . . | Positive | 0.375 |

Certainly, the foregoing is merely a qualitative analysis about the sentiment orientations. To facilitate subsequent calculation, quantitative processing may be further performed. For example, a positive sentiment polarity is set to 1, and a negative sentiment polarity is set to 0. Certainly, other values may also be set, provided that the values of the two sentiment polarities are different. Herein, 0 and 1 may also be understood as intensity of the attitudes of the users. Herein, the qualitative analysis about the sentiment orientations of the product features is performed by using the sentiment lexicon. This is simple and can be implemented easily.

In specific implementation, the association between the sentiment orientation of each product feature and the region may be calculated by using the following formula:

$${χ}^{2} = \sum \frac{{( {n}_{kj} - {E}_{kj} )}^{2}}{{E}_{kj}} \qquad ( 1 )$$

where χ² is the association between the sentiment orientation of the product feature and the region, nₖⱼ is a calculated value of a quantity of comment texts including the product feature and with a sentiment polarity j for the product feature in a k^{th} region, and Eₖⱼ is an expected value of the quantity of comment texts including the product feature and with the sentiment polarity j for the product feature in the k^{th} region.

For example, using city tiers as regions, quantities of comment texts with different sentiment polarities in cities at different tiers are calculated, and a calculation result is shown in the following Table 3.

TABLE 3
Cross table between the city tiers and the sentiment
polarities of the product features

Product feature fᵢ

| City tier | Positive | Negative | Total |
|---|---|---|---|
| Tier-1 cities | n₁₀ | n₁₁ | R₁ |
| Tier-2 cities | n₂₀ | n₂₁ | R₂ |
| Tier-3 cities and | n₃₀ | n₃₁ | R₃ |
| cities at lower | | | |
| tiers | | | |
| Total | C₀ | C₁ | n |

As can be seen from the foregoing Table 3, for a product feature fᵢ, a quantity of comment texts including the product feature is n, and in the comment texts including the product feature, a quantity of comment texts of comment users who belong to the tier-1 cities is R₁; in R₁, a sentiment polarity of the product feature in n₁₀ comment texts is positive, and a sentiment polarity of the product feature in n₁₀ comment texts is negative. Cases in the tier-2 cities, tier-3 cities, and cities at lower tiers are similar to this. In the n comment texts, a sentiment polarity of the product feature in C₀ comment texts is positive, and a sentiment polarity of the product feature in C₁ comment texts is negative.

Based on the foregoing Table 3, a process of calculating an association between a sentiment orientation of the product feature fᵢ and a city tier is approximately as follows:

First, value ranges of k and j are set. The value range of k is [1, 3]. The value range of j is [0, 1].

Then for each k value and j value, calculation is performed by using the following formula (2):

$$\frac{{( {n}_{kj} - {E}_{kj} )}^{2}}{{E}_{kj}} \qquad ( 2 )$$

Finally, values obtained through calculation according to the formula (2) are summated, and the association between the sentiment orientation of the product feature fᵢ and the city tier is obtained.

It may be understood that, the foregoing calculation is based on the city tier that is a region. If the calculation is based on a region, the value range of k may be [1, 7].

In the foregoing process, the expected value Eₖⱼ may be calculated by using the following

$${E}_{kj} = \frac{{R}_{k} {C}_{j}}{n} \qquad ( 3 )$$

where n is a total quantity of the obtained comment texts, Cⱼ is a calculated value of a quantity of comment texts including the product feature and with the sentiment polarity j for the product feature, and Rₖ is a calculated value of a quantity of comment texts including the product feature in the kth region to which the user belongs.

A process of deducing the foregoing formula (3) is as follows:

For a product feature, assuming that a city tier is independent of a sentiment orientation of the product feature,

pₖᵢ=pₖpᵢ (4)

In the foregoing formula (4), pₖᵢ is a probability that a user of a comment text including the product feature belongs to a city tier k and that a sentiment polarity of the product feature is i, pₖ is a probability that the user of the comment text including the product feature belongs to the city tier k, pᵢ is a probability that the sentiment polarity of the product feature in the comment text including the product feature is i, pₖ∝Rᵢ/n, and pₖ∝Cᵢ/n, where n is a quantity of comment texts including the product feature. For meanings of Rₖ and Cᵢ, refer to the foregoing Table 3.

In specific implementation, the extraction of the product features with regional preferences in S4 is based on the associations between the sentiment orientations of the product features and the regions. For example, through calculation in S3, the association χ² between the sentiment orientation of each product feature and the region is obtained. The associations corresponding to the product features may form a set χ²={χ₁²,χ₂²,χ₃², . . . , χₘ²}. If χᵢ² is greater, it indicates that the association between the sentiment orientation of the product feature fᵢ and the region is stronger. For example, if α=0.05 and χᵢ²>χ_{α}²[(k−1)(i−1)], an obvious association exists between the sentiment polarity of the product feature and the regional feature. Based on this, product features corresponding to several strongest associations may be extracted as product features with regional preferences.

For example, using the vehicle as the to-be-analyzed product, the association between the sentiment orientation of each product feature and the region is calculated, as shown in the following Table 4.

TABLE 4
Association χ² between the sentiment orientation of the product feature of the vehicle and the region

| Regional | | | | | Fuel | | | | Price/perfor- |
|---|---|---|---|---|---|---|---|---|---|
| feature | dƒ | Space | Power | Manipulation | consumption | Comfortability | Exterior | Interior | mance ratio |
| City tier | 2 | 5.599 | 0.041 | 0.548 | 5.129 | 2.827 | 1.176 | 0.251 | 1.479 |
| City region | 6 | 14.134 | 8.416 | 3.524 | 6.326 | 2.468 | 11.935 | 8.255 | 2.982 |

where χ_{0.05}²(2) = 5.991, χ_{0.05}²(6) = 12.592, χ_{0.25}²(2) = 2.773, and χ_{0.25}²(6) = 7.841.

From the foregoing Table 4, it can be seen that, associations between the two product features space and fuel consumption and city tiers are strong, and are respectively 5.599 and 5.129, close to χ_{0.05}²(2)=5.991. It indicates that an obvious impact exists. Therefore, space and fuel consumption may be extracted as product features with regional preferences. In addition, it can be seen that, associations between sentiment orientations of space, exterior, interior, and power, and the regions are also strong, and in particular, for space and exterior, values of the association χ² reach 14.134 and 11.935, close to χ_{0.05}²(6)=12.592. Therefore, space and exterior may be extracted as product features with regional preferences.

In specific implementation, the process of determining a preferential region for the product feature in S5 may be as follows:

S51. Calculate the difference between the calculated value and the expected value of the quantity of comment texts including the product feature with the sentiment polarity in each region.

S52. Use a region with a greatest difference among the regions as the preferential region for the product feature in view of the sentiment polarity.

For example, for a product feature, seven regions are used as an example for description.

Obvious liking: For each region, a difference between an actually calculated quantity and an expected quantity of comment texts that include the product feature and in which a sentiment polarity of the product feature is positive and a comment user belongs to the region is calculated; and then a region with a greatest difference is used as an obvious-liking region, that is, a preferential region with a positive sentiment polarity for the product feature.

Obvious disliking: For each region, a difference between an actually calculated quantity and an expected quantity of comment texts that include the product feature and in which a sentiment polarity of the product feature is negative and a comment user belongs to the region is calculated; and then a region with a greatest difference is used as an obvious-disliking region, that is, a preferential region with a negative sentiment polarity for the product feature.

Based on the foregoing Table 4, for the product feature fuel consumption with a regional preference, a cross table between a sentiment orientation thereof and a city tier is shown in the following Table 5.

TABLE 5
Cross table between the sentiment orientation of fuel
consumption and the city tier

| | | City tier | | | |
|---|---|---|---|---|---|
| | | | | Tier-3 cities | |
| Sentiment polarity of the | | Tier-1 | Tier-2 | and cities at | |
| fuel consumption feature | | cities | cities | lower tiers | Total |
| Positive | Calculated | 469 | 341 | 660 | 1470 |
| | quantity | | | | |
| | Expected | 491 | 344 | 635 | |
| Negative | Calculated | 336 | 223 | 381 | 940 |
| | quantity | | | | |
| | Expected | 314 | 220 | 406 | |

| | | | | |
|---|---|---|---|---|
| Total | 805 | 564 | 1041 | 2410 |

From the foregoing Table 5, it can be seen that, a quantity of comments with a positive sentiment polarity for fuel consumption in the tier-3 cities and cities at lower tiers is obviously greater than the expected value, but a quantity of comments with a negative sentiment polarity for fuel consumption in the tier-1 cities is obviously greater than the expected value. This indicates that users in small- and medium-sized cities have lower requirements for performance of the fuel consumption feature, but users in the tier-1 cities attach more importance to the performance of the fuel consumption feature.

Based on the foregoing Table 4, for the product feature space with a regional preference, a cross table between a sentiment orientation thereof and a region is shown in the following Table 6.

TABLE 6
Cross table between the sentiment orientation of space and the region

| Sentiment | | City region | | | | | | | |
|---|---|---|---|---|---|---|---|---|---|
| polarity of the | | North | North | East | South | Central | North | South | |
| space feature | | East | China | China | China | China | West | West | Total |
| Positive | Calculated | 52 | 80 | 296 | 81 | 128 | 35 | 119 | 791 |
| | Expected | 44.3 | 75.2 | 326.6 | 69.6 | 121.4 | 44.3 | 109.6 | |
| Negative | Calculated | 83 | 149 | 669 | 131 | 242 | 100 | 215 | 1619 |
| | Expected | 90.7 | 153.8 | 668.4 | 142.4 | 248.6 | 90.7 | 224.4 | |

| | | | | | | | | |
|---|---|---|---|---|---|---|---|---|
| Total | 135 | 229 | 995 | 212 | 370 | 135 | 334 | 2410 |

From the foregoing Table 6, it can be seen that, a quantity of comments with a positive sentiment polarity for the product feature space in South China and South West regions is obviously greater than the expected value, but a quantity of comments with a positive sentiment polarity in East China and North West regions is obviously less than the expected value. This indicates that users in the South China and South West regions are satisfied with the product feature space, but users in the East China and North West regions have relatively higher requirements on the product feature space.

In specific implementation, after the product features of the to-be-analyzed product are extracted from the obtained comment texts in S1, each product feature may be further matched with a product attribute model in a configuration document of the to-be-analyzed product, and the preferential region for the product feature is used as a preferential region for the product attribute model. In the matching process, the product attribute model in the configuration document of the product may be matched by using a keyword index.

Herein, the product feature is matched with the product attribute model, and the obtained preferential region for the product feature is the preferential region for the product attribute model. Even for a same product, configurations may also vary. For example, in a same mobile phone model, some mobile phones have a 2 GB memory, and some mobile phones have a 3 GB memory. Herein, the product feature is matched with the product attribute model in the configuration document of the product, and a preferential region in the configuration may be obtained. A preferential region in another configuration may vary. It can be seen that, matching the product feature with the product attribute model makes the identified preferential region more accurate.

In specific implementation, preferential regions for a plurality of products that are in a same category as the to-be-analyzed product may be identified separately, and a preferential region for each product in the plurality of products is obtained; and further, preferential regions for products in the category are formed according to the preferential regions for the plurality of different products in the same category. This helps formulate a marketing strategy for a product category.

According to a second aspect, the present invention further provides an apparatus for identifying a preferential region for a product, where the apparatus includes:

a first feature extraction module, configured to obtain comment texts of users in different regions for a to-be-analyzed product, and extract product features of the to-be-analyzed product from the obtained comment texts, where the regions are tiers of cities to which the users belong or are regions to which the users belong;

a sentiment polarity determining module, configured to determine, according to an opinion word about each product feature in each comment text, a sentiment polarity of a user for the product feature in the comment text;

an association calculation module, configured to calculate, according to the sentiment polarity of each product feature in each comment text including the product feature and a region to which the user of the comment text including the product feature belongs, an association between a sentiment orientation of the product feature and the region;

a second feature extraction module, configured to extract product features with regional preferences from the product features according to associations between sentiment orientations of the product features and the regions; and

a preferential region calculation module, configured to determine, for each extracted product feature with a regional preference according to a difference between a calculated value and an expected value of a quantity of comment texts including the product feature and with a same sentiment polarity for the product feature in each region, a preferential region for the product feature in view of the sentiment polarity.

It may be understood that, the apparatus for identifying a preferential region according to the present invention is configured to perform the method for identifying a preferential region according to the present invention. For content such as related content explanations and descriptions, implementation methods, examples, and beneficial effects, refer to corresponding content in the foregoing method for identifying a preferential region. Details are not described again herein.

Although multitudinous specific details are described in the specification of the present invention, it can be understood that, the embodiments of the present invention can be practiced without these specific details. In some examples, well-known methods, structures, and technologies are not shown in detail to avoid vague understandings about the specification.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. A method for identifying a preferential region for a product, comprising:
obtaining comment texts of users in different regions for a to-be-analyzed product, and extracting product features of the to-be-analyzed product from the obtained comment texts, wherein the regions are tiers of cities to which the users belong or are regions to which the users belong;
determining, according to an opinion word about each product feature in each comment text, a sentiment polarity of a user for the product feature in the comment text;
calculating, according to the sentiment polarity of each product feature in each comment text comprising the product feature and a region to which the user of the comment text comprising the product feature belongs, an association between a sentiment orientation of the product feature and the region;
extracting product features with regional preferences from the product features according to associations between sentiment orientations of the product features and the regions; and
determining, for each extracted product feature with a regional preference according to a difference between a calculated value and an expected value of a quantity of comment texts comprising the product feature and with a same sentiment polarity for the product feature in each region, a preferential region for the product feature in view of the sentiment polarity.

2. The method according to claim 1, wherein the step of extracting product features of the to-be-analyzed product from the obtained comment texts comprises:
performing Chinese word segmentation on each comment text, and extracting nouns and noun phrases from a word segmentation result;
extracting a frequent item set from the extracted nouns and noun phrases by using an association rule; and
performing synonym aggregation on nouns and/or noun phrases in the frequent item set, and removing non product feature words from the frequent item set.

3. The method according to claim 1, wherein the step of determining, according to an opinion word about each product feature in each comment text, a sentiment polarity of a user for the product feature in the comment text comprises:
determining a type of a sentiment lexicon to which the opinion word belongs; and
determining, according to the type of the sentiment lexicon, the sentiment polarity of the user for the product feature in the comment text.

4. The method according to claim 1, wherein the opinion word about each product feature in each comment text is an adjective in a preset quantity of characters near the product feature in the comment text.

5. The method according to claim 1, wherein the association between the sentiment orientation of each product feature and the region is calculated by using the following formula:
$${χ}^{2} = \sum \frac{{( {n}_{kj} - {E}_{kj} )}^{2}}{{E}_{kj}}$$
wherein χ² is the association between the sentiment orientation of the product feature and the region, nₖⱼ is a calculated value of a quantity of comment texts comprising the product feature and with a sentiment polarity j for the product feature in a kth region, and Eₖⱼ is an expected value of the quantity of comment texts comprising the product feature and with the sentiment polarity j for the product feature in the kth region.

6. The method according to claim 5, wherein the expected value Eₖⱼ is calculated by using the following formula:
$${E}_{kj} = \frac{{R}_{k} {C}_{j}}{n}$$
wherein n is a total quantity of the obtained comment texts, Cⱼ is a calculated value of a quantity of comment texts comprising the product feature and with the sentiment polarity j for the product feature, and Rₖ is a calculated value of a quantity of comment texts comprising the product feature in the kth region to which the user belongs.

7. The method according to claim 1, wherein the step of determining a preferential region for the product feature in view of the sentiment polarity comprises:
calculating the difference between the calculated value and the expected value of the quantity of comment texts comprising the product feature with the sentiment polarity in each region; and
using a region with a greatest difference among the regions as the preferential region for the product feature in view of the sentiment polarity.

8. The method according to any one of claims 1-7, further comprising:
after extracting the product features of the to-be-analyzed product from the obtained comment texts, matching each product feature with a product attribute model in a configuration document of the to-be-analyzed product, and using the preferential region for the product feature as a preferential region for the product attribute model.

9. The method according to any one of claims 1-7, further comprising:
separately identifying preferential regions for a plurality of products that are in a same category as the to-be-analyzed product; and forming preferential regions for products in the category according to the preferential regions for the plurality of different products in the same category.

10. An apparatus for identifying a preferential region for a product, comprising:
a first feature extraction module, configured to obtain comment texts of users in different regions for a to-be-analyzed product, and extract product features of the to-be-analyzed product from the obtained comment texts, wherein the regions are tiers of cities to which the users belong or are regions to which the users belong;
a sentiment polarity determining module, configured to determine, according to an opinion word about each product feature in each comment text, a sentiment polarity of a user for the product feature in the comment text;
an association calculation module, configured to calculate, according to the sentiment polarity of each product feature in each comment text comprising the product feature and a region to which the user of the comment text comprising the product feature belongs, an association between a sentiment orientation of the product feature and the region;
a second feature extraction module, configured to extract product features with regional preferences from the product features according to associations between sentiment orientations of the product features and the regions; and
a preferential region calculation module, configured to determine, for each extracted product feature with a regional preference according to a difference between a calculated value and an expected value of a quantity of comment texts comprising the product feature and with a same sentiment polarity for the product feature in each region, a preferential region for the product feature in view of the sentiment polarity.
